(19) United States
(12) Patent Application Publication
(10) Pub. No.: US 2008/0260194 A1
(43) Pub. Date: Oct. 23, 2008

(54) MICROPHONE SLEEVE

(76) Inventor: Donald Bruce Pooley, Farmington Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/027,786

(22) Filed: Feb. 7, 2008

Related U.S. Application Data
(60) Provisional application No. 60/888,653, filed on Feb. 7, 2007.

(51) Int. Cl. H04R 19/04

(52) U.S. Cl. 381/361

(57) ABSTRACT

A microphone sleeve for a handheld microphone can be used to alter the overall appearance of a microphone and/or to make a microphone easier to hold, handle, and/or grip. A sleeve encloses at least a portion of a microphone's body, without interfering with the microphone's audio receiving end, controls, wires, or antennas.

### BACKGROUND

A handheld microphone is typically an integral piece of equipment for entertainers and public speakers, including singers, musicians, comedians, and MCs. During a performance, a handheld microphone is often visible to the performer's audience. The lead singer of a musical group, for example, is often seen holding a handheld microphone during a performance. Some entertainers may want a microphone of a particular color or style to match or accent their overall look. Unfortunately, many handheld microphones are designed to look uniform and plain. Purchasing several microphones of different colors may be prohibitively expensive, and changing the color or appearance of a microphone may be difficult and impractical.

### BRIEF DESCRIPTION OF THE DRAWINGS

FIG. 1 illustrates a handheld microphone and a sleeve according to an embodiment.

FIG. 2 illustrates a handheld microphone and a sleeve according to another embodiment.

FIG. 3 illustrates a handheld microphone and a sleeve according to another embodiment.

FIG. 4 is top view of a sleeve according to an embodiment.

FIG. 5 illustrates a sleeve that includes an exterior ornament according to an embodiment.

### DETAILED DESCRIPTION OF PREFERRED EMBODIMENTS

Disclosed are various sleeves and coverings for handheld microphones. A sleeve or covering, made in accordance with the present disclosure, may be used on a handheld microphone to alter the overall appearance of the microphone and/or to make the microphone easier to hold, handle, and/or grip. Such sleeves enclose at least a portion of a microphone's body, without interfering with the microphone's audio receiving end, controls, wires, or antennas. Such coverings may be used to change the microphone's exterior color and shape, thereby changing the overall appearance of the microphone. Furthermore, such coverings may be used to make a microphone easier to hold by changing the shape and/or texture of the microphone's exterior. In addition, such sleeves made in accordance with the present disclosure may be inexpensive and easily interchangeable, allowing a performer to readily customize a particular microphone. Using a variety of such sleeves, a performer could create many different visual impressions while using the same microphone, even during a live performance. For example, a singer could use the same microphone during an entire performance, but use different sleeves for different songs, thereby creating a different visual impression of the microphone for each song.

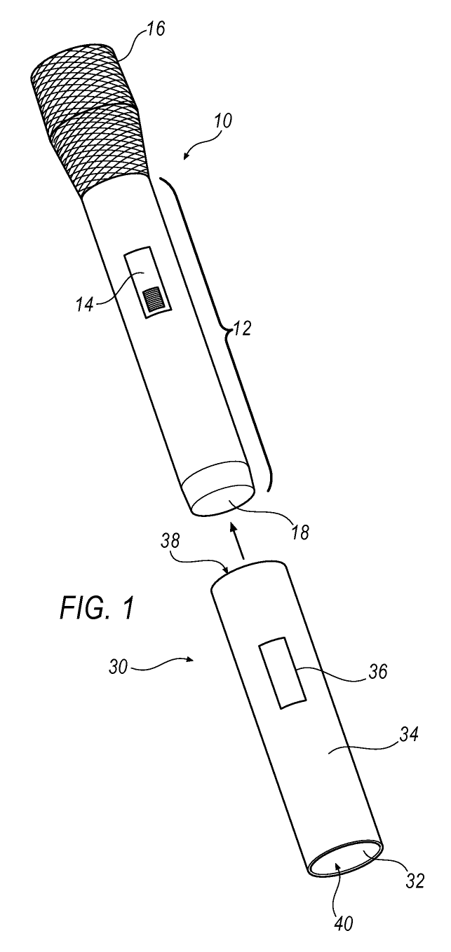

Handheld microphones may come in a wide variety of shapes and sizes, and may use wired or wireless communication systems. FIG. 1 illustrates one example of a handheld microphone 10 that includes a body 12, a switch 14, and a mesh guard 16. Microphone 10 may be a vocal microphone, such as the model SM58 vocal microphone made by Shure Inc. of Niles Ill. Body 12 encloses the internal components of microphone 10, and may be cylindrical, as shown in FIG. 1, or may be various other shapes, such as a slightly tapered cylinder, truncated cone, etc. As shown in FIG. 1, switch 14 is disposed on body 12 and may provide various functions, such as turning microphone 10 on or off. Mesh guard 16 is disposed on an audio receiving portion and protects the audio receiver, which may lie at the upper end of body 12. Microphone 10 also includes a lower end 18, which may be flat, or may include an antenna or a wire.

Microphone 10 may also be used with a microphone stand. A microphone stand generally includes feet or a base for stabilizing the stand, an elongated body attached to and rising up from the feet or base, and a holster attached to an upper portion of the body for holding microphone 10. The holster is generally a truncated hollow cylinder having an opening that receives, for example, body 12 of microphone 10. A microphone, such as microphone 10, generally slides into the holster creating an interference fit, securing the microphone in place. The holster may also be angled, generally shaped in a truncated frustoconical fashion, to create a tighter interference fit along body 12.

FIG. 1 also illustrates one example of a sleeve 30. Sleeve 30 generally includes an interior surface 32 and an exterior surface 34. As shown in FIG. 1, sleeve 30 is shaped to conform to body 12. For example, interior surface 34 may have a cylindrical shape such that it can substantially enclose and conform to body 12. Sleeve 30 also generally includes a first end 38 and a second end 40. First end 38 generally includes an opening such that sleeve 30 may slide over body 12 of microphone 10, generally by way of lower end 18, as shown in FIG. 1. If microphone 10 is a wired microphone, it may be more efficient or convenient to slide sleeve 30 over mesh guard 16, or to remove mesh guard 16 and slide sleeve 30 over the audio receiving end of microphone 10. For that purpose, second end 40 may also include or form an opening allowing sleeve 30 to slide over mesh guard 16 and then lie over body 12. Sleeve 30 may also be installed by threading the wire of microphone 10 through the openings in first and second ends 38, 40, and then sliding sleeve 30 over body 12. When installed on microphone 10, sleeve 30 generally substantially encloses body 12, but typically does not encroach on mesh guard 16, or dangle below lower end 18 of microphone 10. This generally ensures that sleeve 30 does not interfere with microphone's 10 audio receiver housed in mesh guard 16.

Sleeve 30 may also include a switch access 36, corresponding in location to switch 14. When sleeve 30 is installed over body 12, switch access 36 typically facilitates unobstructed access to switch 14. Switch access 36 may be a cut-out or hole in sleeve 30 that may be covered by a flap. A flap may be moveable from an open position, thereby exposing switch 14, to a closed position, thereby covering or enclosing switch 14.

Generally, sleeve 30, as shown in FIG. 1, may be made from any number of different materials. Sleeve 30 may be thick or thin, elastic, semi-elastic, or inelastic, flexible, semi-flexible, or rigid, etc. Preferably, sleeve 30 is made from a thin, flexible, stretchable material. In one embodiment, sleeve 30 may be made from various thin, flexible, elastic materials, such as spandex, elastane, Lycra®, or various nylons, felts, etc. Such materials may be provided in various thicknesses, generally ranging from about 20 to 4300 deniers. For example, in one embodiment, sleeve 30 is made from a spandex having approximately 20 denier. In another embodiment, sleeve 30 may also be made from various semi-rigid or rigid materials such as various plastics, metals, composites, meshes, etc. Sleeve 30 may also be made from various flaccid stretch materials that include one or more multi-colored novelty designs to provide different appearances to microphone 10.

In one embodiment, sleeve 30 is made from a rectangular piece of flexible material that measures approximately 3½-4 inches by approximately 6-7½ inches. Of course, such dimensions are merely exemplary and exact dimensions may be dependent upon the dimensions of a particular brand, model, or style of microphone. The piece of material can then be bonded/attached to itself to form a cylindrical structure as shown in FIG. 1 by any one of the following: a 3 or 4 thread serer stitch, a single stitch, a metal or nylon zipper, a hook and loop fastener, glue, a sonic weld, a hook and a complimentary catch, a button and a hole, a metal or nylon pressure clip, adhesive tape, or the like. The particular fastener may depend on the type of material selected, or may depend on cost, appearance, or some other factor. In such an embodiment, sleeve 30 may be made by first selecting a flexible, elastic material that includes an ornamental design, cutting a substantially rectangular piece of the material, such that the piece includes two short sides measuring at least approximately 3 inches and two long sides measuring at least approximately 6 inches; and forming sleeve 30 by fastening the two long sides together by any of the above mentioned ways.

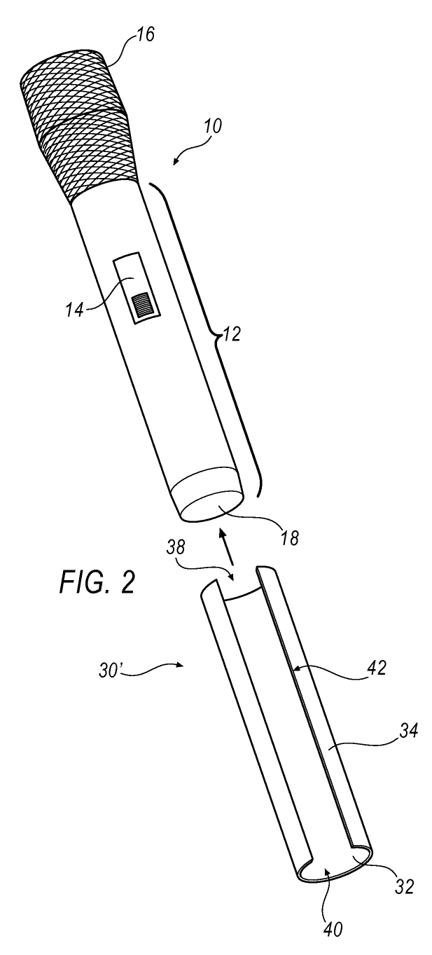

FIG. 2 illustrates another embodiment of a sleeve 30′. As shown in FIG. 2, sleeve 30′ is generally cylindrical with an opening 42 running along the major axis from first end 38 to second end 40. Sleeve 30′ may also be described as forming an elongated ‘C’ shape. Preferably, sleeve 30′ is made from a rigid or semi-rigid material, such as a soft plastic or metal. In another embodiment, sleeve 30′ may be made from a flexible material and simply include a fasteners to secure sleeve 30′ around body 12. Like sleeve 30, sleeve 30′ may be installed by sliding over either mesh guard 16 or lower end 18. Sleeve 30′ may also be installed over body 12 by sliding microphone 10 through opening 42. In one embodiment, sleeve 30′ is made from a resilient material such that opening 42 may be expanded to allow microphone 10 to slide through. Opening 42 may then be allowed to contract, creating an interference or friction fit over body 12, securing sleeve 30′ onto body 12 of microphone 10.

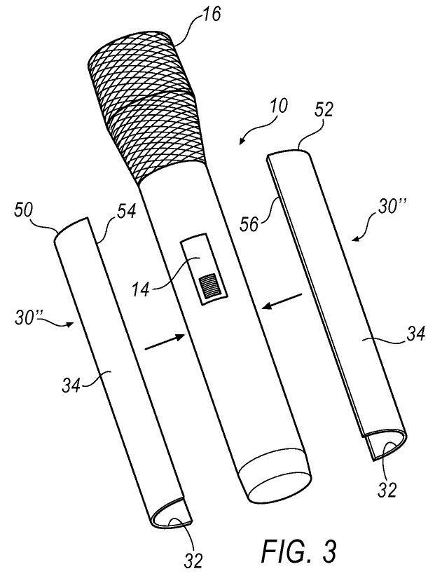

FIG. 3 illustrates another embodiment of a sleeve 30″. Sleeve 30″ generally includes two or more pieces that adjoin or at least substantially enclose body 12 of microphone 10. As shown in FIG. 3, sleeve 30″ includes two pieces, 50, 52. Pieces 50, 52 generally have complementary edges 54, 56 that may connect or abut to secure pieces 50,52 together. Complementary edges 54, 56 may utilize any number of different fastening systems including tongue and groove, magnets, interlocking clips, buttons, snaps, etc. Sleeve 30″ may be made from a rigid or semi-rigid material, like various plastics or metals, or may be made from a flexible material as well. Sleeve 30″ may be installed by separating pieces 50, 52, placing body 12 of microphone 10 within either piece, and then attaching pieces 50, 52 together around body 12. Either piece, 50 or 52, may include a switch access, or pieces 50, 52 may include complementary notches that form a switch access.

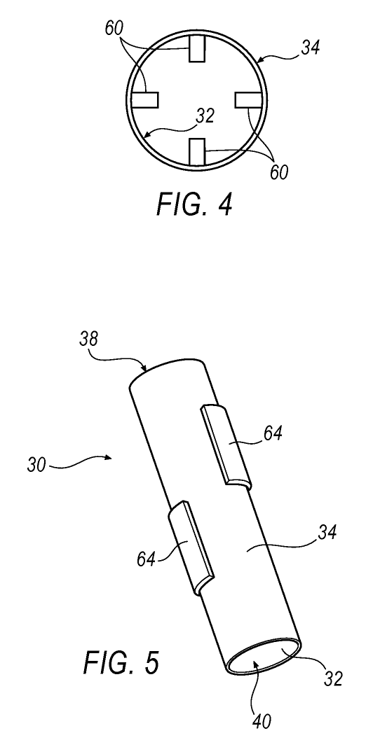

In each embodiment, interior surface 32 may include a padding layer, an absorption layer, one or more spacers, or the like. A Padding layer may include lining interior surface 32 with a cushion, such as foam or rubber. As shown in FIG. 4, interior surface 32 may also include one or more individual spacers 60 disposed on interior surface 32 to provide a predetermined gap between interior surface 32 and body 12. Spacer 60 may be a projection, or an individual protrusion that keeps body 12 from rubbing against interior surface 32. Furthermore, interior surface 32 may include various fastening or friction elements to help detachably secure sleeve 30 in place over body 12 of microphone 10. For example, interior surface 32 may include a portion of a hook-and-loop type fastener that may be secured to a complementary hook-and-loop type fastener attached to body 12. Various other detachable fastening systems may also be used to secure sleeve 30 in place.

A sleeve may be made from any material and may be any color, texture, pattern, etc. Generally, exterior surface 34 is the most visible to an audience and is typically the surface by which a performer will handle microphone 10. Therefore, to create a unique visual impression of microphone 10, exterior surface 34 may be colored, textured, or include one or more ornaments, decorations, or the like. For example, exterior surface 32 may include one or more ornaments 64 as illustrated in FIG. 5. Ornament 64 may be a jewel, an accessory, a metal stud, a rhinestone, glitter, lettering, an appendage, or the like. An appendage, for example, may be a light-weight structure made from foam that can be attached to sleeve 30. Such ornaments or decorations may be attached by any type of fastening device or system, including stitching, glue, snaps, hook-and-loop fasteners, or the like. Sleeve 30 may also include lettering, stickers, stamps, or some additional ornamentation representing a logo, a name, a place, an event, or a date. In addition, sleeve 30 may include a drawstring for cinching or tightening sleeve 30 around body 12 of microphone 10. Sleeve 30 may also include a wrist strap, for example, that may be sewn or otherwise secured to sleeve 30, thereby enabling a performer to releasably secure microphone 10 to the performer's wrist by way of the wrist strap attached to sleeve 30. Furthermore, ornament 64 may be an electrical component, such as a light emitting diode (LED), a lighting display, an electronic text display, a laser, etc.

Exterior surface 34 may also include a sticky or adhesive substance to help prevent dropping microphone 10. Exterior surface 34 may also include one or more friction elements to increase a performer's grip over microphone 10. Exterior surface 34 may also include additional material to change the overall shape of the microphone and sleeve assembly. For example, external surface 34 may be rectangular, oval, wavy, ribbed, etc. A shape may be for decorative purposes or may be useful for improving one's grip over microphone 10. In addition, sleeve 30 may include a moisture absorption layer, for example, over external surface 34, or disposed adjacent to interior surface 32. Such a moisture absorption layer may wick or collect sweat from a performer's hand, thereby reducing the possibility of accidentally dropping microphone 10 due to excessive moisture or sweat.

A sleeve may also be used in conjunction with a microphone stand. For example, a sleeve may be made of a thin material, allowing the microphone and sleeve assembly to be secured in the holster of a microphone stand. A sleeve may also enlarge exterior surface 34 of a sleeve, allowing a microphone to be used with a larger holster in which it otherwise may not fit. For example, a sleeve may be used to make a microphone compatible with a previously incompatible holster of a microphone stand.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed embodiments will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

I claim:

1. A microphone sleeve, comprising:
a covering having a first end, a second end, an interior surface, and an exterior surface, the interior surface configured to cover a substantial portion of a body of a handheld microphone, the first end forming an opening configured to allow a lower end of the handheld microphone to pass through the opening.

2. The microphone sleeve of claim 1, wherein the covering is a one-piece tube made from a thin, flexible, elastic material.

3. The microphone sleeve of claim 1, further comprising an opening formed in the second end to allow a lower end of the handheld microphone to pass through the opening.

4. The microphone sleeve of claim 1, wherein the covering is a generally ‘C’ shaped slotted tube made from a semi-rigid material.

5. The microphone sleeve of claim 1, wherein the covering is formed by fastening two semi-cylindrical pieces around the body of the handheld microphone, wherein each piece is made from a semi-rigid material.

6. The microphone sleeve of claim 1, wherein the covering is made from a flexible, elastic material that is less than approximately 30 deniers and configured to substantially conform to the shape of the body of the handheld microphone.

7. The microphone sleeve of claim 1, further comprising an opening that extends along a major axis from the first end to the second end, the covering forming an elongated ‘C’ shape and made from a semi-rigid material that allows the opening to expand and contract.

8. The microphone sleeve of claim 1, further comprising a switch access that is positioned to allow access to a switch located on the body of the handheld microphone.

9. The microphone sleeve of claim 1, further comprising an ornament.

10. The microphone sleeve of claim 9, wherein the ornament is at least one of a jewel, a metal stud, a rhinestone, a portion of glitter, a logo, and a series of letters.

11. The microphone sleeve of claim 1, further comprising an appendage made from a light-weight material and fastened to the exterior surface of the covering.

12. The microphone sleeve of claim 1, further comprising at least one of a light emitting diode (LED), a lighting display, an electronic text display, and a laser.

13. The microphone sleeve of claim 1, further comprising a friction layer disposed on the exterior surface of the covering.

14. The microphone sleeve of claim 1, further comprising at least one of a padding layer, an absorption layer, and a spacer disposed on the interior surface.

15. A microphone sleeve, comprising
a covering made from a flaccid tubular shaped construction of a flexible, elastic material, wherein the covering includes a first end, a second end, an interior surface, and an exterior surface, the interior surface configured to cover a substantial portion of a body of a handheld microphone, the first and second ends forming respective openings that are configured to allow a lower end of the handheld microphone to pass through the openings.

16. The microphone sleeve of claim 15, wherein the flexible, elastic material is less than approximately 30 deniers and configured to substantially conform to the shape of the body of the handheld microphone.

17. The microphone sleeve of claim 15, further comprising at least one of a jewel, a metal stud, a rhinestone, glitter, a logo, an appendage, a foam attachment, a light emitting diode (LED), a lighting display, an electronic text display, a laser, a sticker, and a stamp.

18. The microphone sleeve of claim 15, further comprising a friction layer disposed on the exterior surface of the covering.

19. The microphone sleeve of claim 15, further comprising at least one of a padding layer, an absorption layer, and a spacer disposed on the interior surface.

20. A method, comprising:
selecting a flexible, elastic material that includes an ornamental design;
cutting a substantially rectangular piece of the material, such that the piece includes two short sides and two long sides; and
forming a microphone sleeve by fastening the two long sides together to form a flaccid tube-shaped covering having a first end, a second end, an interior surface, and an exterior surface, the interior surface configured to cover a substantial portion of a body of a handheld microphone, and the first end forming an opening configured to allow a lower end of the handheld microphone to pass through the opening.
